(19) United States
(12) Patent Application Publication
(10) Pub. No.: US 2025/0375972 A1
(43) Pub. Date: Dec. 11, 2025

(54) DRYING DEVICE AND RECORDING DEVICE

(71) Applicant: SEIKO EPSON CORPORATION, Tokyo (JP)

(72) Inventors: Tadashi AIZAWA, MATSUMOTO-SHI (JP); Tsuneyuki SASAKI, MATSUMOTO-SHI (JP)

(21) Appl. No.: 19/249,241

(22) Filed: Jun. 25, 2025

(30) Foreign Application Priority Data
Jun. 8, 2024 (JP) 2024-104900

(51) Int. Cl. B41J 11/00; B41J 29/377

(52) U.S. Cl. CPC B41J 11/0024; B41J 29/377

(57) ABSTRACT

A drying device includes a heating section that heats a medium on which was ejected pigment ink, a first contact section provided between the heating section and the medium and configured to contact the medium, and a second contact section provided at a position sandwiching the medium with respect to the heating section and configured to contact the medium. The heating section, in a first period, vaporizes water contained in the pigment ink by heating the pigment ink in a state where the medium is sandwiched between the first and second contact sections. In a second period, solvent contained in the pigment ink is vaporized by heating the pigment ink in a state where the medium is sandwiched between the first and second contact sections. The drying device releases the medium from being sandwiched by the first and second contact sections after the medium is heated.

The present application is based on, and claims priority from JP Application Serial Number 2024-104900, filed Jun. 28, 2024, the disclosure of which is hereby incorporated by reference herein in its entirety.

### BACKGROUND

### 1. Technical Field

The present disclosure relates to a drying device and a recording device.

### 2. Related Art

For example, JP-A-2019-155811 discloses a drying device for drying a medium onto which liquid was ejected. Such a drying device generates a strong electric field with respect to a medium by supplying a high-frequency voltage between a first electrode and a second electrode. By this, liquid ejected onto the medium can be dried. Pigment ink may be used as liquid to be ejected onto the medium. Pigment ink contains a pigment, water, and a solvent, and the solvent may contain, for example, glycerin.

However, in such a liquid ejection device, there is a possibility that thermal denaturation may occur with respect to the medium. Therefore, it is desirable to dry the medium while maintaining the quality of the medium.

### SUMMARY

A drying device to overcome the above-described problem includes a heating section that heats a medium on which was ejected pigment ink containing a pigment, water, and a solvent; a first contact section that is provided between the heating section and the medium and that is configured to contact the medium; and a second contact section that is provided at a position sandwiching the medium with respect to the heating section and that is configured to contact the medium, wherein the heating section, in a first period, vaporizes the water contained in the pigment ink by heating the pigment ink that was ejected onto the medium in a state where the medium is sandwiched between the first contact section and the second contact section and then, in a second period, vaporizes the solvent contained in the pigment ink by heating the pigment ink that was ejected onto the medium in a state where the medium is sandwiched between the first contact section and the second contact section and the drying device releases the medium from being sandwiched by the first contact section and the second contact section after the medium is heated by the heating section.

A recording device to overcome the above-described problem includes a recording section that performs recording by ejecting pigment ink containing a pigment, water, and a solvent onto a medium; a heating section that heats the medium onto which the pigment ink was ejected by the recording section; a first contact section that is provided between the heating section and the medium and that is configured to contact the medium; and a second contact section that is provided at a position sandwiching the medium with respect to the heating section and that is configured to contact the medium, wherein the heating section, in a first period, vaporizes the water contained in the pigment ink by heating the pigment ink that was ejected onto the medium in a state where the medium is sandwiched between the first contact section and the second contact section and then, in a second period, vaporizes the solvent contained in the pigment ink by heating the pigment ink that was ejected onto the medium in a state where the medium is sandwiched between the first contact section and the second contact section and the recording device releases the medium from being sandwiched by the first contact section and the second contact section after the medium is heated by the heating section.

### BRIEF DESCRIPTION OF THE DRAWINGS

FIG. 1 is a schematic diagram showing a recording system of a first embodiment.

FIG. 2 is a perspective view showing a heating section of the first embodiment.

FIG. 3 is a schematic diagram showing a drying device of the first embodiment.

FIG. 4 is a schematic diagram showing a first contact section of the first embodiment.

FIG. 5 is a schematic diagram showing a drying step of the first embodiment.

FIG. 6 is a schematic diagram showing a drying device of a second embodiment.

FIG. 7 is a schematic diagram showing a drying device of a third embodiment.

FIG. 8 is a flowchart showing a drying control process of the third embodiment.

### DESCRIPTION OF EMBODIMENTS

### First Embodiment

Hereinafter, an embodiment of a recording system including a drying device and a recording device will be described. In the following description, a direction intersecting a vertical direction Z is referred to as a width direction X, and a direction intersecting the vertical direction Z and the width direction X is referred to as a depth direction Y. One direction along the width direction X is defined as a first width direction X1, and the other direction along the width direction X is defined as a second width direction X2. One direction along the depth direction Y is defined as a first depth direction Y1, and the other direction along the depth direction Y is defined as a second depth direction Y2. An upper side in the vertical direction Z is referred to as an upper direction Z1, and a lower side in the vertical direction Z is referred to as a lower direction Z2. The vertical direction Z corresponds to an example of a first direction. Plan view from the vertical direction Z is simply referred to as plan view.

### Configuration of Recording System 10

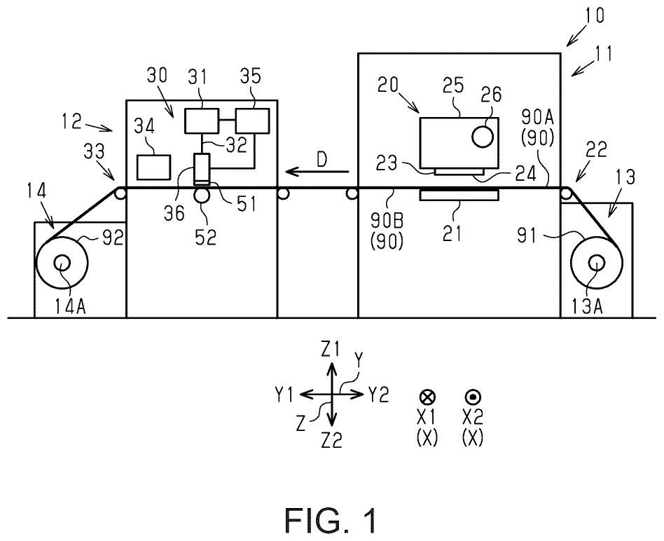

As shown in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 after recording onto which liquid was ejected.

Liquid is pigment ink. Pigment ink contains a pigment, water, and a solvent. A solvent may include, for example, glycerin. Glycerin is a solvent for preventing clogging in a nozzle for ejecting liquid. Vaporization of glycerin improves the abrasion resistance of the medium 90 onto which pigment ink was ejected. The medium 90 includes a front surface 90A and a back surface 90B. The medium 90 is a fabric, but may be, for example, paper.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet type printer that performs recording by ejecting pigment ink as liquid onto the medium 90.

The recording system 10 includes a drying device 12. The drying device 12 is configured to dry the medium 90 after recording onto which the recording device 11 ejected liquid. In particular, the drying device 12 dries the medium 90 after recording by generating electromagnetic waves.

The recording system 10 includes a feeding section 13. The feeding section 13 feeds the medium 90 before recording to the recording device 11. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 before recording that is wound and stacked. The medium 90 may be elongated. In this way, the feed roller 13A holds the medium 90 to be fed to the recording device 11.

The recording system 10 includes a winding section 14. The winding section 14 winds up the medium 90 after recording by the recording device 11. In particular, the winding section 14 winds up the medium 90 after recording and drying by the drying device 12. The winding section 14 includes a winding roller 14A. The winding roller 14A extends along the width direction X. In the width direction X, the width of the winding roller 14A is longer than the width of the medium 90. The winding roller 14A is configured to rotatably hold a second roll body 92. The second roll body 92 is the medium 90 after recording that is wound and stacked. In this way, the winding roller 14A winds up the medium 90 that was recorded by the recording device 11 and dried by the drying device 12.

### Configuration of Recording Device 11

Here, a configuration of the recording device 11 will be described in detail.

The recording device 11 includes a recording section 20, a recording support section 21, and a recording transport section 22. The recording section 20 is configured to perform recording on the medium 90 by ejecting liquid onto the medium 90. The recording section 20 is configured to perform recording on the medium 90 by ejecting liquid onto the front surface 90A of the medium 90. The recording section 20 performs recording on the medium 90 supported by the recording support section 21. The recording section 20 performs recording on the medium 90 transported by the recording transport section 22.

The recording section 20 includes a head 23. The head 23 may be a serial head or may be a line head. A serial head is a head that scans in the width direction X of the medium 90. A line head is a head that records simultaneously across the width direction X of the medium 90.

The head 23 includes a nozzle surface 24 in which a plurality of nozzles (not shown) are opened. The nozzle surface 24 is a surface facing the lower direction Z2. The nozzle surface 24 is a surface facing the front surface 90A of the medium 90 transported by the recording transport section 22. Each of the plurality of nozzles is configured to open up in the lower direction Z2. Each of the plurality of nozzles is configured to eject liquid.

The recording section 20 may include a carriage 25 and a carriage support section 26. The carriage 25 is configured to support the head 23. The carriage support section 26 extends along the width direction X. The carriage support section 26 supports the carriage 25 so as to be movable along the width direction X. The carriage 25 is movable in the width direction X along the carriage support section 26 by a driving force from a drive source (not shown).

The recording support section 21 is configured to support the medium 90 transported by the recording transport section 22. The recording support section 21 is positioned in the lower direction Z2 of the recording section 20. The recording support section 21 supports the back surface 90B of the medium 90 transported by the recording transport section 22. The recording support section 21 is positioned in the lower direction Z2 of the head 23.

The recording transport section 22 is configured to transport the medium 90 in a transport direction D. The transport direction D is a direction along the depth direction Y. The recording transport section 22 may include a plurality of rollers. Although the recording transport section 22 transports the medium 90 in the transport direction D using the plurality of rollers, the recording transport section 22 may transport the medium 90 in the transport direction D using a transport belt driven by a plurality of rollers. The recording transport section 22 may perform intermittent transport in which the transport and stop of the medium 90 are repeated.

### Configuration of Drying Device 12

Next, a configuration of the drying device 12 will be described in detail.

The drying device 12 includes a drying unit 30. The drying unit 30 is configured to dry the medium 90 after recording. That is, the drying device 12 sets the medium 90 on which recording was performed by the recording section 20 as a target to be dried.

The drying unit 30 is configured to dry the medium 90 after recording by generation of electromagnetic waves. The drying unit 30 is positioned in the upper direction Z1 of the medium 90, but may be positioned in the lower direction Z2 of the medium 90, or may be positioned both in the upper direction Z1 and in the lower direction Z2 of the medium 90. In this way, the vertical direction Z is a direction toward the medium 90.

The drying device 12 includes a high-frequency voltage generation section 31. The high-frequency voltage generation section 31 is configured to generate a high-frequency voltage. The high-frequency voltage generation section 31 supplies a high-frequency voltage to the drying unit 30 through a transmission line 32.

The transmission line 32 is a line for connecting the drying unit 30 and the high-frequency voltage generation section 31. The transmission line 32 is capable of transmitting a high-frequency voltage from the high-frequency voltage generation section 31 to the drying unit 30. That is, the transmission line 32 is capable of transmitting a high-frequency voltage.

The transmission line 32 may be a coaxial cable, but is not limited to coaxial cable. The transmission line 32 may include a first line and a second line. The first line may be a core line of the transmission line 32. The second line may be an electromagnetic shield that covers the first line.

The drying device 12 includes a drying transport section 33. The drying transport section 33 is configured to transport the medium 90 in the transport direction D. The drying transport section 33 may transport the medium 90 in the transport direction D using a plurality of rollers. The drying transport section 33 transports the medium 90 in the transport direction D at a predetermined speed. The drying transport section 33 performs intermittent transport in which transport and stop of the medium 90 are repeated. Slackening of the medium 90 may occur between the recording transport section 22 and the drying transport section 33.

The drying device 12 includes a control section 35. The control section 35 controls the drying device 12. Specifically, the control section 35 controls the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be composed of one or more dedicated hardware circuits. The control section 35 may be configured with an application specific integrated circuit that executes at least a part of various processes. The control section 35 may be composed of a processor and a circuit including a combination of hardware circuits. The processor includes a CPU and memories such as a RAM and a ROM. The memory stores program codes or commands configured to cause the CPU to perform processes. Memory, that is computer-readable medium, includes any readable medium that can be accessed by a general-purpose or dedicated computer.

The drying unit 30 includes a heating section 36. That is, the drying device 12 includes the heating section 36. The drying unit 30 may include a plurality of heating sections 36. The heating section 36 may have a rectangular shape in plan view. The heating section 36 may be arranged so that the width direction X is a longitudinal direction.

The heating section 36 is configured to generate electromagnetic waves in response to application of a high-frequency voltage. By this, the heating section 36 is configured to heat the medium 90 onto which liquid was ejected by the recording section 20. The heating section 36 is an electromagnetic wave generation section.

The heating section 36 generates an alternating current electric field by generating electromagnetic waves. An electromagnetic wave generated by the heating section 36 has an electric field as a main component. The heating section 36 can significantly reduce induction of a magnetic field due to a generated electric field as compared with an electromagnetic wave generation section that generates normal electromagnetic waves.

As a specific example, the heating section 36 generates electromagnetic waves of 2.4 GHz, but is not limited to this. The heating section 36 may generate, for example, electromagnetic waves of 3 MHz to 300 MHz. The heating section 36, for example, may generate electromagnetic waves of 300 MHz to 30 GHz, and among these, may generate electromagnetic waves of 10 MHz to 20 GHz.

The heating section 36 dries the medium 90 by heating the medium 90 from the front surface 90A. Specifically, the heating section 36 heats liquid ejected onto the medium 90 from the front surface 90A. The heating section 36 dries the medium 90 by vaporizing liquid ejected onto the medium 90. That is, the heating section 36 is a method of drying the medium 90 regardless of whether or not water vapor is saturated around the medium 90. Therefore, the heating section 36 can dry the medium 90 without blowing dry gas in which water vapor is not saturated to the medium 90.

The drying device 12 includes a blower section 34. The blower section 34 is provided downstream of the heating section 36 in the transport direction D. The blower section 34 is provided downstream of a first contact section 51 and a second contact section 52, which will be described later, in the transport direction D. The blower section 34 is configured to blow air to the medium 90. The blower section 34 can remove vaporized water and solvent from the vicinity of the medium 90 by blowing air to the medium 90 after drying the medium 90. This can improve the drying performance and the abrasion resistance.

### Configuration of Heating Section 36

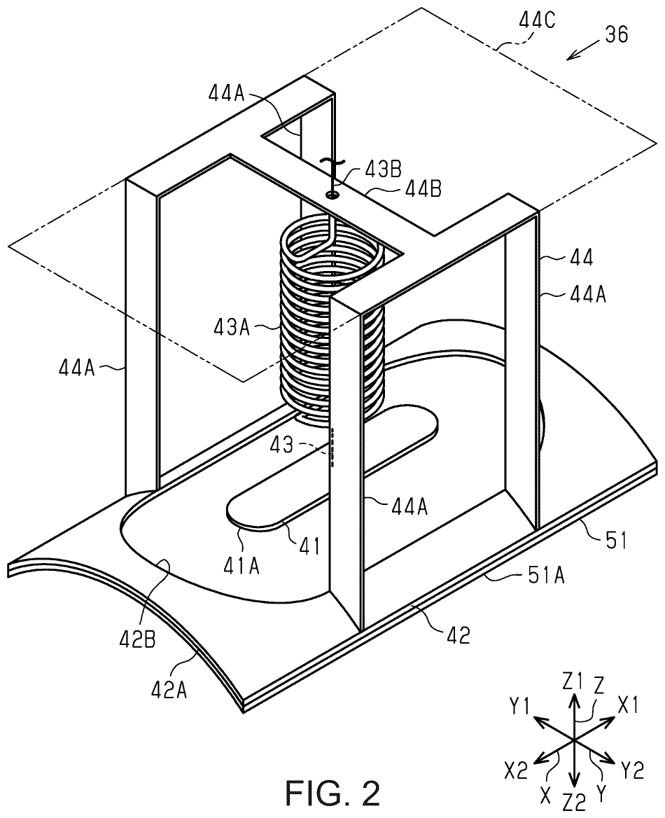

As shown in FIG. 2, the heating section 36 includes a first electrode 41, a second electrode 42, a first conductor 43, and a second conductor 44. FIG. 2 is a view in which the first electrode 41 and second electrode 42 are arranged on a lower direction Z2 side.

The first electrode 41 has a plate shape. The first electrode 41 is elongated in the width direction X in plan view. That is, the first electrode 41 extends in the width direction X in plan view. The first electrode 41 may have a rectangular shape in plan view.

The first electrode 41 includes a first electrode surface 41A. The first electrode surface 41A is a surface facing the lower direction Z2. That is, the first electrode surface 41A is a surface facing the front surface 90A of the medium 90. The first electrode 41 is arranged so that the first electrode surface 41A is in contact with the first contact section 51.

The second electrode 42 has a plate shape. The second electrode 42 includes a second electrode surface 42A. The second electrode surface 42A is a surface facing the lower direction Z2. That is, the second electrode surface 42A is a surface facing the front surface 90A of the medium 90. The second electrode 42 is arranged so that the second electrode surface 42A is in contact with the first contact section 51.

The second electrode 42 is provided so as to have an arc shape with an axis along the width direction X as a center. The second electrode 42 is provided so as to have an arc shape with its center in the depth direction Y facing the upper direction Z1 and both ends in the depth direction Y facing the lower direction Z2. By this, the second electrode surface 42A is provided so as to include a curved surface shape centered on an axis along the width direction X.

The second electrode 42 includes an opening section 42B. The opening section 42B has a rounded rectangular shape in plan view, but may have a rectangular shape. The first electrode 41 is positioned in the opening section 42B in plan view. That is, the second electrode 42 is arranged so as to surround the first electrode 41 in plan view.

The first conductor 43 is configured to electrically connect the transmission line 32 and the first electrode 41. The first conductor 43 includes a coil 43A. The coil 43A extends in the vertical direction Z. One end of the coil 43A is connected to the first electrode 41. The other end of the coil 43A is connected to a conductor wire 43B.

The second conductor 44 is configured to electrically connect the transmission line 32 and the second electrode 42. The second conductor 44 may include a columnar support 44A. The second conductor 44 may include a plurality of columnar supports 44A. The columnar supports 44A are electrically connected to the second electrode 42. The columnar support 44A extends from the second electrode 42 in the upper direction Z1. The columnar support 44A is made of metal.

The second conductor 44 may include a connection section 44B. The connection section 44B is electrically connected to the columnar supports 44A. The connection section 44B is provided at an upper end section of the columnar supports 44A. The connection section 44B connects a plurality of the columnar supports 44A. The connection section 44B may be integrated with the columnar support 44A. The connection section 44B may have an H-shaped in plan view. The connection section 44B is made of metal.

The second conductor 44 may include a top plate 44C. The top plate 44C is positioned in the upper direction 21 of the connection section 44B. The top plate 44C is electrically connected to the connection section 44B. The top plate 44C may be integrated with the connection section 44B. The top plate 44C is made of metal.

By configuring the heating section 36 in this manner, when a high-frequency voltage is applied, the first electrode 41 and the second electrode 42 heat the medium 90 by generating an electromagnetic wave in response to application of a high-frequency voltage.

Such a heating section 36 can transmit a large amount of thermal energy to the medium 90 due to generation of electromagnetic waves. The heating section 36 is not of a thermal conduction type but of an electromagnetic wave type, and does not need to include a member such as a heating wire for heating. This allows the heating section 36 to be made smaller in size.

The minimum separation distance between the first electrode 41 and the second electrode 42 is equal to or less than 1/10 of the wavelength of an electromagnetic wave output from the heating section 36. By this, electromagnetic waves generated when a high-frequency voltage is applied can be attenuated in the vicinity of the first electrode 41 and the second electrode 42. By this, it is possible to reduce the intensity of an electromagnetic wave that reaches a distant place from the first electrode 41 and the second electrode 42. That is, electromagnetic waves generated from the heating section 36 are very strong in the vicinity of the first electrode 41 and the second electrode 42, and are very weak in a distant place.

Such a heating section 36 can intensively generate an alternating current electric field in the vicinity of the first electrode 41 and the second electrode 42 by appropriately controlling the frequency band of an electromagnetic wave to be generated. In other words, it is possible to suppress the influence on the surroundings accompanying the generation of electromagnetic waves beyond the vicinity of the first electrode 41 and the second electrode 42. The vicinity of the first electrode 41 and the second electrode 42 may correspond to a range of, for example, 3 mm to 3 cm.

### First Contact Section 51 and Second Contact Section 52

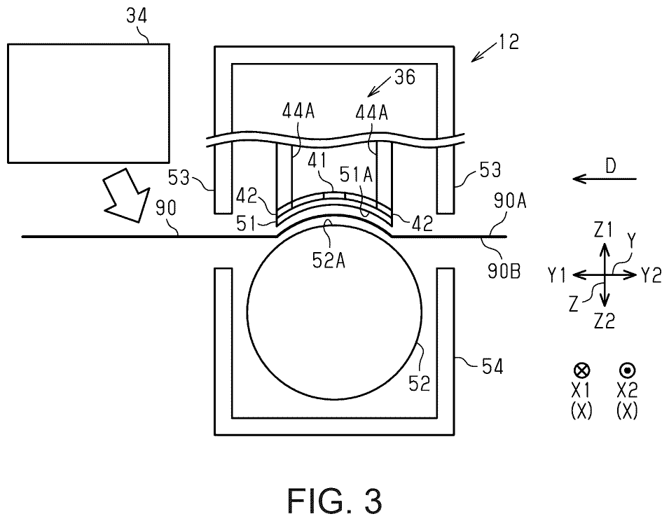

As shown in FIG. 3, the drying device 12 includes a first contact section 51 and a second contact section 52. The first contact section 51 is provided between the heating section 36 and the medium 90. The first contact section 51 is capable of contacting the medium 90 from the front surface 90A of the medium 90.

The first contact section 51 may have a plate shape. The first contact section 51 is provided so as to have an arc shape with an axis along the width direction X as a center. The first contact section 51 is provided so as to have an arc shape with its center in the depth direction Y facing the upper direction Z1 and both ends in the depth direction Y facing the lower direction Z2. That is, the first contact section 51 includes a curved surface.

The first contact section 51 includes a first contact surface 51A. The first contact section 51 is provided such that the first contact surface 51A contacts the front surface 90A of the medium 90. The first contact section 51 may contact the first electrode 41 and second electrode 42 from the upper direction Z1. The first contact section 51 protects the first electrode 41 and the second electrode 42 from the medium 90.

The first contact section 51 is made of a material that transmits electromagnetic waves generated by the heating section 36. The first contact section 51 is composed of a member having insulating properties. The first contact section 51 may be a glass plate. The first contact section 51 may be made of silicon glass having heat resistance. That is, the first contact section 51 may be configured to include glass. The first contact section 51 may be a ceramic with high transmittance. The first contact section 51 may be made of a resin with a low dissipation factor. The first contact section 51 may be made of polypropylene. The first contact section 51 may be made of polyethylene.

The second contact section 52 is provided at a position relative to the heating section 36 such that the medium 90 is sandwiched therebetween. The second contact section 52 is capable of contacting the medium 90 from the back surface 90B of the medium 90. The second contact section 52 may be a roller including a curved surface, and the second contact section 52 may be a roller for transporting the medium 90 in the transport direction D.

The second contact section 52 includes a second contact surface 52A. The second contact surface 52A constitutes a curved surface of the roller. The second contact section 52 is provided such that the second contact surface 52A contacts the back surface 90B of the medium 90.

The second contact section 52 may be silicone rubber. The second contact section 52 may be aromatic polyether ketone. The second contact section 52 may be a heat-resistant polyimide material, or a heat-resistant polyimide material may be attached to the second contact section 52. The second contact section 52 may be a glass plate. The second contact section 52 may be made of silicon glass having heat resistance. That is, the second contact section 52 may be configured to include glass. In this way, the medium 90 is in contact with the first contact section 51 at the front surface 90A and is in contact with the second contact section 52 at the back surface 90B. By this, the medium 90 is sandwiched between the first contact section 51 and the second contact section 52. That is, the heating section 36 is configured to heat the medium 90 in a state of being sandwiched by the first contact section 51 and the second contact section 52.

The first contact section 51 may include the first contact surface 51A that is in contact with the medium 90 and that has an indentation-protrusion shape. The second contact section 52 may include the second contact surface 52A that is in contact with the medium 90 and that has an indentation-protrusion shape. The first contact surface 51A and the second contact surface 52A may be formed in an indentation-protrusion shape by a dimple structure.

This reduces the contact areas between the medium 90 and the first contact surface 51A and the second contact surface 52A. Therefore, liquid ejected onto the medium 90 is unlikely to deposit to the first contact surface 51A, and the medium 90 is likely to be separated from the first contact surface 51A and the second contact surface 52A. By this, it is possible to improve the transport property of the medium 90. In addition, vaporized moisture is likely to remain between the medium 90 and the first contact surface 51A and the second contact surface 52A.

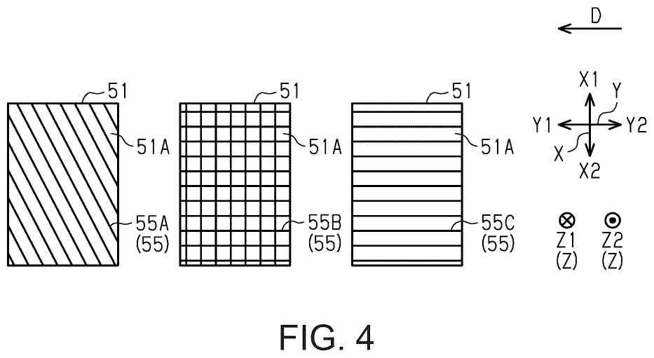

As shown in FIG. 4, the first contact section 51 and the second contact section 52 may be provided with groove sections 55 in addition to a dimple structure on the first contact surface 51A and the second contact surface 52A. As a specific example, the first contact section 51 may include first groove sections 55A on the first contact surface 51A. The first groove section 55A is a groove forming an oblique stripe. When the medium 90 is a fabric, the texture of the medium 90 tends to be provided along the width direction X and the depth direction Y. In such a case, by making the indentation-protrusion of the first groove sections 55A and the indentation-protrusion of the medium 90 not coincident with each other, it is possible to suppress imbalance of a region in which vaporized moisture is remained.

The first contact section 51 may include second groove sections 55B on the first contact surface 51A. The second groove sections 55B are lattice-shaped grooves extending along the width direction X and the depth direction Y. In this case, the amount of vaporized moisture to be remained can be increased. The second groove sections 55B may be a lattice-shaped grooves that do not extend along the width direction X and the depth direction Y. The first contact section 51 may include third groove sections 55C on the first contact surface 51A. The third groove sections 55C are grooves along the depth direction Y.

As shown in FIG. 3, the drying device 12 includes a first heat insulating section 53 and a second heat insulating section 54. The first heat insulating section 53 is provided on an upper direction Z1 side of the medium 90. The second heat insulating section 54 is provided on a lower direction Z2 side of the medium 90. The first heat insulating section 53 and the second heat insulating section 54 are provided so as to secure a transport path of the medium 90.

The first heat insulating section 53 is configured to cover the heating section 36 and the first contact section 51 from the upper direction Z1. The first heat insulating section 53 suppresses heat dissipation from the heating section 36, the first contact section 51, and the medium 90. The first heat insulating section 53 suppresses cooling of the heating section 36, the first contact section 51, and the medium 90 by air blown from the blower section 34.

The second heat insulating section 54 is configured to cover the second contact section 52 from the lower direction Z2. The second heat insulating section 54 suppresses heat dissipation from the second contact section 52 and the medium 90. The second heat insulating section 54 suppresses cooling of the second contact section 52 and the medium 90 by air blown from the blower section 34.

The medium 90 is transported in the transport direction D, and thus a state of the medium 90 changes from a state of being sandwiched between the first contact section 51 and the second contact section 52 to a released state of not being sandwiched between the first contact section 51 and the second contact section 52. That is, in the drying device 12, after the medium 90 is heated by the heating section 36, the medium 90 is released from being sandwiched by the first contact section 51 and the second contact section 52.

When the medium 90 is in the released state, the medium 90 receives air blown from the blower section 34. A blowing direction of the blower section 34 is desirably a direction as indicated by an arrow in FIG. 3. That is, the blowing direction of the blower section 34 is desirably a direction toward the medium 90 and is desirably the second depth direction Y2 where the first contact section 51 and the second contact section 52 are positioned in the transport direction D. With such a configuration, it is possible to quickly remove water and a solvent vaporized from the medium 90 between the first contact section 51 and the second contact section 52 from the medium 90.

### Drying Principle of Medium 90

Pigment ink as liquid is ejected onto the medium 90 by the recording device 11. Pigment ink is different from dye ink that permeates into the medium 90, and is recorded by being fixed to the front surface 90A of the medium 90.

Pigment ink contains water in addition to a pigment. Pigment ink contains glycerin as a solvent. When the temperature of pigment ink reaches approximately 100° C., water contained in the pigment ink vaporizes. When the temperature of pigment ink reaches approximately 290° C., glycerin contained in the pigment ink vaporizes.

Pigment ink ejected onto the front surface 90A of medium 90 is heated by electromagnetic waves generated by the heating section 36. By this, water and a solvent contained in pigment ink are vaporized, and the medium 90 is dried. In particular, glycerin contained in pigment ink is vaporized, and thus it is possible to improve the abrasion resistance of the medium 90.

Electromagnetic waves generated from the heating section 36 do not heat gas around the medium 90. Therefore, electromagnetic waves do not directly heat the medium 90 itself, but heat pigment ink. As described above, the generation of a electromagnetic wave itself is not a direct cause of the thermal denaturation of the medium 90. Pigment ink is heated by the generation of electromagnetic waves, and the heat of the pigment ink is transmitted to the medium 90. The heat of the pigment ink is excessively transmitted to the medium 90, which may cause the thermal denaturation of the medium 90.

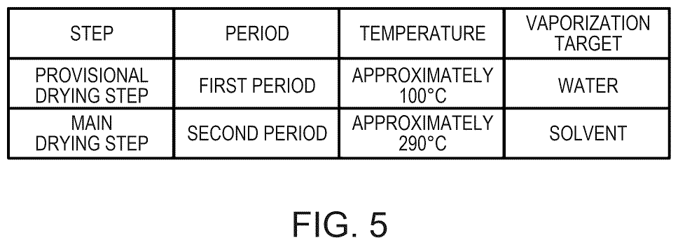

As shown in FIG. 5, a drying step includes a provisional drying step and a main drying step. The provisional drying step is performed in a first period. The first period is a period until the time required for the provisional drying step elapses. For example, the first period is a period for vaporizing water contained in pigment ink when the temperature of the pigment ink becomes approximately 100° C.

The main drying step is performed in a second period. The second period is a period after the first period. The second period is a period until the time required for the main drying step elapses. For example, the second period is a period for vaporizing a solvent contained in pigment ink when the temperature of the pigment ink becomes approximately 290° C. The second period is a period in which the medium 90 is heated at a higher temperature than in the first period.

In this way, the heating section 36 heats the medium 90 in a state of being sandwiched between the first contact section 51 and the second contact section 52 in the first period. By this, the heating section 36 vaporizes water contained in pigment ink.

Thereafter, the heating section 36 heats the medium 90 in a state of being sandwiched between the first contact section 51 and the second contact section 52 in the second period. By this, the heating section 36 vaporizes a solvent contained in pigment ink.

The medium 90 is sandwiched between the first contact section 51 and the second contact section 52. By this, it is possible to suppress the imbalance of the distance between the medium 90 and the heating section 36. Even in a case of the medium 90 that is easily contracted by heating by the heating section 36, it is possible to suppress contraction of the medium 90. The airtightness between the first contact section 51 and the second contact section 52 and the medium 90 is improved. By this, the medium 90 can be dried in an environment in which pigment ink is unlikely to be oxidized.

In particular, the amount of moisture vaporized varies depending on the type of liquid ejected onto the medium 90, and the degree to which the vaporized moisture remains tends to vary depending on the type of medium 90. Therefore, in the main drying step, the amount of heat generated by liquid tends to vary depending on the degree to which moisture vaporized in the provisional drying step remains in the vicinity of the medium 90.

Therefore, by performing the main drying step in a state where the medium 90 is sandwiched between the first contact section 51 and the second contact section 52, the vaporized moisture easily remains in the vicinity of the medium 90, and the difference in the amount of moisture in which the vaporized moisture remains in the vicinity of the medium 90 is reduced.

In particular, the first contact surface 51A and the second contact surface 52A are formed in an indentation-protrusion shape, and the vaporized moisture is likely to remain in the vicinity of the medium 90. Therefore, it is possible to reduce the difference in the amount of heat generation of liquid depending on the type of the medium 90 and the type of the liquid.

### Operations and Effects of First Embodiment

Operations and effects of the first embodiment will be described.
(1-1) The heating section 36 vaporizes water contained in pigment ink by heating the medium 90 in a state of being sandwiched by the first contact section 51 and the second contact section 52 in the first period. Thereafter, the heating section 36 vaporizes a solvent contained in pigment ink by heating the medium 90 in a state of being sandwiched by the first contact section 51 and the second contact section 52 in the second period. According to this configuration, when a solvent is vaporized in the second period, moisture vaporized in the first period remains in the vicinity of the medium 90. By this, it is possible to reduce the difference in the amount of heat generation of pigment ink depending on the type of the medium 90 and the type of liquid. In addition, since the airtightness between the first contact section 51 and the second contact section 52 and the medium 90 can be improved, the medium 90 can be dried in an environment in which pigment ink is unlikely to be oxidized. It is possible to suppress the imbalance of the distance between the medium 90 and the heating section 36. It is possible to suppress the contraction of the medium 90 in accordance with the heating of the medium 90. Therefore, it is possible to suppress the occurrence of thermal denaturation with respect to the medium 90. Therefore, the medium 90 can be dried while maintaining the quality of the medium 90.
(1-2) The heating section 36 heats the medium 90 onto which pigment ink was ejected by generating electromagnetic waves in response to application of a high-frequency voltage. According to this configuration, the medium 90 can be dried in a short time by boiling pigment ink ejected onto the medium 90. In addition, even when electromagnetic waves having high intensity are generated, it is possible to suppress the occurrence of thermal denaturation with respect to the medium 90. Therefore, the medium 90 can be dried while maintaining the quality of the medium 90.
(1-3) The first contact section 51 and second contact section 52 may include the first contact surface 51A and second contact surface 52A that are in contact with the medium 90 and that have an indentation-protrusion shape. According to this configuration, it is possible to increase the amount of moisture that is remained in the vicinity of the medium 90, and it is possible to improve the transport property of the medium 90. Therefore, the medium 90 can be dried while maintaining the quality of the medium 90.
(1-4) The first contact section 51 is configured to include glass. According to this configuration, the first contact section 51 contains glass, and thus it is possible to improve the transport property of the medium 90. In addition, electromagnetic waves from the heating section 36 are unlikely to be absorbed, and thus it is possible to improve the drying performance of the medium 90. Therefore, the medium 90 can be dried while maintaining the quality of the medium 90.
(1-5) The first contact section 51 includes a curved surface. According to this configuration, in a case where the medium 90 is transported along a curved transport path, it is possible to improve the airtightness between the medium 90 and the first contact section 51. Therefore, it is possible to suppress the occurrence of thermal denaturation with respect to the medium 90. Therefore, the medium 90 can be dried while maintaining the quality of the medium 90.
(1-6) The second contact section 52 is a roller including a curved surface. According to this configuration, in a case where the medium 90 is transported along the second contact section 52 including a curved surface, it is possible to improve the airtightness between the medium 90 and the second contact section 52, and it is possible to improve the transport property of the medium 90. Therefore, it is possible to suppress the occurrence of thermal denaturation with respect to the medium 90. Therefore, the medium 90 can be dried while maintaining the quality of the medium 90.
(1-7) The blower section 34 blows air to the medium 90 in the transport direction D with respect to the first contact section 51 and the second contact section 52. According to this configuration, after water is vaporized from the medium 90 in the first period and a solvent is vaporized from the medium 90 in the second period, water and a solvent vaporized from the medium 90 can be removed from the vicinity of the medium 90. Therefore, it is possible to improve the drying performance of the medium 90 and to improve the abrasion resistance. Therefore, the medium 90 can be dried while maintaining the quality of the medium 90.
(1-8) The heating section 36 is provided on a front surface 90A side of the medium 90. Therefore, by heating liquid from a front surface 90A side of the medium 90 onto which liquid was ejected, the medium 90 can be dried.

### Second Embodiment

Next, a second embodiment will be described. In the following description, the same configurations as those of the above-described embodiment will not be described or will be described in a simplified manner, and configurations different from those of the above-described embodiment will be described.

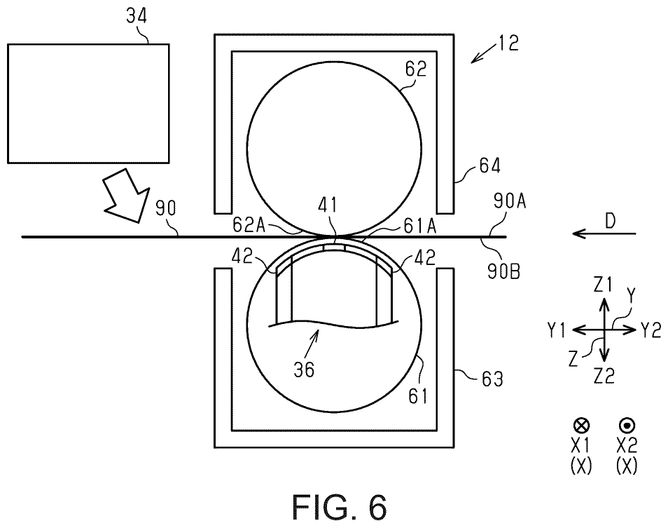

As shown in FIG. 6, in the second embodiment, the drying device 12 includes a first contact section 61 and a second contact section 62. The first contact section 61 is capable of contacting the medium 90 from the back surface 90B of the medium 90. The first contact section 61 may be a roller including a curved surface, and the first contact section 61 may be a roller for transporting the medium 90 in the transport direction D.

The first contact section 61 is provided so as to incorporate the heating section 36. The heating section 36 is provided inside the first contact section 61. That is, the heating section 36 is provided below the medium 90 in the lower direction Z2. The heating section 36 is provided such that the first electrode 41 and the second electrode 42 face the medium 90. The first contact section 61 does not contact the first electrode 41 and the second electrode 42. Therefore, even when the first contact section 61 rotates, the heating section 36 is configured not to rotate.

The first contact section 61 includes a first contact surface 61A. The first contact surface 61A constitutes a curved surface of a roller. The first contact section 61 is provided such that the first contact surface 61A contacts the back surface 90B of the medium 90.

The first contact section 61 may be silicone rubber. The first contact section 61 may be a glass plate. The first contact section 61 may be made of silicon glass having heat resistance. That is, the first contact section 61 may be configured to include glass.

The second contact section 62 is capable of contacting the medium 90 from the front surface 90A of the medium 90. The second contact section 62 includes a second contact surface 62A. The second contact section 62 may include the same configuration as the second contact section 52.

In this way, the medium 90 contacts the first contact section 61 on the back surface 90B, and contacts the second contact section 62 on the front surface 90A. By this, the medium 90 is sandwiched between the first contact section 61 and the second contact section 62. That is, the heating section 36 is configured to heat the medium 90 in a state of being sandwiched between the first contact section 61 and the second contact section 62.

The first contact section 61 may include the first contact surface 61A that is in contact with the medium 90 and that has an indentation-protrusion shape. The second contact section 62 may include the second contact surface 62A that is in contact with the medium 90 and that has an indentation-protrusion shape.

The drying device 12 includes a first heat insulating section 63 and a second heat insulating section 64. The first heat insulating section 63 is provided on a lower direction Z2 side of the medium 90. The second heat insulating section 64 is provided on an upper direction Z1 side of the medium 90. The first heat insulating section 63 and the second heat insulating section 64 are provided so as to secure a transport path of the medium 90.

The first heat insulating section 63 is configured to cover the heating section 36 and the first contact section 61 from the lower direction Z2. The first heat insulating section 63 suppresses heat dissipation from the heating section 36, the first contact section 61, and the medium 90. The first heat insulating section 63 suppresses cooling of the heating section 36, the first contact section 61, and the medium 90 by air blown from the blower section 34.

The second heat insulating section 64 is configured to cover the second contact section 62 from the upper direction Z1. The second heat insulating section 64 suppresses heat dissipation from the second contact section 62 and the medium 90. The second heat insulating section 64 suppresses cooling of the second contact section 62 and the medium 90 by air blown from the blower section 34.

### Operation and Effect of Second Embodiment

An operation and effect of the second embodiment will be described.
(2-1) Both the first contact section 61 and the second contact section 62 are rollers including a curved surface. Therefore, it is possible to suppress the occurrence of thermal denaturation with respect to the medium 90, and to improve the transport property of the medium 90. Therefore, the medium 90 can be dried while maintaining the quality of the medium 90.

### Third Embodiment

Next, a third embodiment will be described.

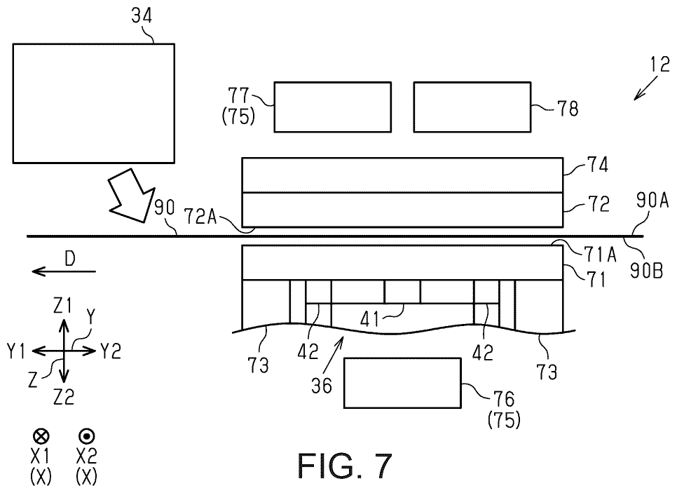

As shown in FIG. 7, in the third embodiment, the drying device 12 includes a first contact section 71 and a second contact section 72. The first contact section 71 is capable of contacting the medium 90 from the back surface 90B of the medium 90.

The first contact section 71 may have a flat plate shape. The first contact section 71 includes a first contact surface 71A. The first contact section 71 is provided such that the first contact surface 71A includes the width direction X and the depth direction Y. The first contact section 71 may be a glass plate. The first contact section 71 may be made of silicon glass having heat resistance. That is, the first contact section 71 may be configured to include glass. The first contact section 71 may include the first contact surface 71A that is in contact with the medium 90 and that has an indentation-protrusion shape.

The heating section 36 is provided below the medium 90 in the lower direction Z2. The heating section 36 is provided such that the first electrode 41 and the second electrode 42 face the medium 90. The first electrode 41 may have a flat plate shape. By this, the first electrode surface 41A is provided to have a planar shape. The second electrode 42 may have a flat plate shape. By this, the second electrode surface 42A is provided to have a planar shape.

The second contact section 72 is capable of contacting the medium 90 from the front surface 90A of the medium 90. The second contact section 72 may have a flat plate shape. The second contact section 72 includes a second contact surface 72A. The second contact section 72 is provided such that the second contact surface 72A includes the width direction X and the depth direction Y.

The second contact section 72 may be a glass plate. The second contact section 72 may be made of silicon glass having heat resistance. That is, the second contact section 72 may be configured to include glass. The second contact section 72 may include the second contact surface 72A that is in contact with the medium 90 and that has an indentation-protrusion shape.

The drying device 12 includes a first heat insulating section 73 and a second heat insulating section 74. The first heat insulating section 73 is provided on a lower direction Z2 side of the medium 90. The second heat insulating section 74 is provided on an upper direction Z1 side of the medium 90. The first heat insulating section 73 and the second heat insulating section 74 are provided so as to secure a transport path of the medium 90.

The first heat insulating section 73 is configured to cover the heating section 36 and the first contact section 71 from the lower direction Z2. The first heat insulating section 73 suppresses heat dissipation from the heating section 36, the first contact section 71, and the medium 90. The first heat insulating section 73 suppresses cooling of the heating section 36, the first contact section 71, and the medium 90 by air blown from the blower section 34.

The second heat insulating section 74 is configured to cover the second contact section 72 from the upper direction Z1. The second heat insulating section 74 suppresses heat dissipation from the second contact section 72 and the medium 90. The second heat insulating section 74 suppresses cooling of the second contact section 72 and the medium 90 by air blown from the blower section 34.

The drying device 12 includes a movement section 75. The movement section 75 moves the heating section 36, the first contact section 71, and the second contact section 72 along the depth direction Y. The movement section 75 may move the first heat insulating section 73 and the second heat insulating section 74 along the depth direction Y.

The movement section 75 may include a first movement section 76 and a second movement section 77. The first movement section 76 moves the heating section 36 and the first contact section 71 along the depth direction Y. The first movement section 76 may move the first heat insulating section 73 along the depth direction Y. The second movement section 77 moves the second contact section 72 along the depth direction Y. The second movement section 77 may move the second heat insulating section 74 along the depth direction Y.

The drying device 12 includes a raising/lowering section 78. The raising/lowering section 78 raises and lowers the second contact section 72 along the vertical direction Z. The raising/lowering section 78 may raise and lower the second heat insulating section 74 along the vertical direction Z.

When the raising/lowering section 78 lowers the second contact section 72, the medium 90 is sandwiched between the first contact section 71 and the second contact section 72. When the raising/lowering section 78 raises the second contact section 72, the medium 90 is released from a state of being sandwiched between the first contact section 71 and the second contact section 72.

In this way, the medium 90 contacts the first contact section 71 at the back surface 90B, and contacts the second contact section 72 at the front surface 90A. By this, the medium 90 is sandwiched between the first contact section 71 and the second contact section 72. That is, the heating section 36 is configured to heat the medium 90 in a state of being sandwiched by the first contact section 71 and the second contact section 72.

When the medium 90 is transported in the transport direction D, the movement section 75 moves the heating section 36, the first contact section 71, and the second contact section 72 in the transport direction D. In this case, the movement section 75 moves the heating section 36, the first contact section 71, and the second contact section 72 at the same movement speed as the transport speed of the medium 90. By this, the drying device 12 can dry the medium 90 while transporting the medium 90. Drying control process

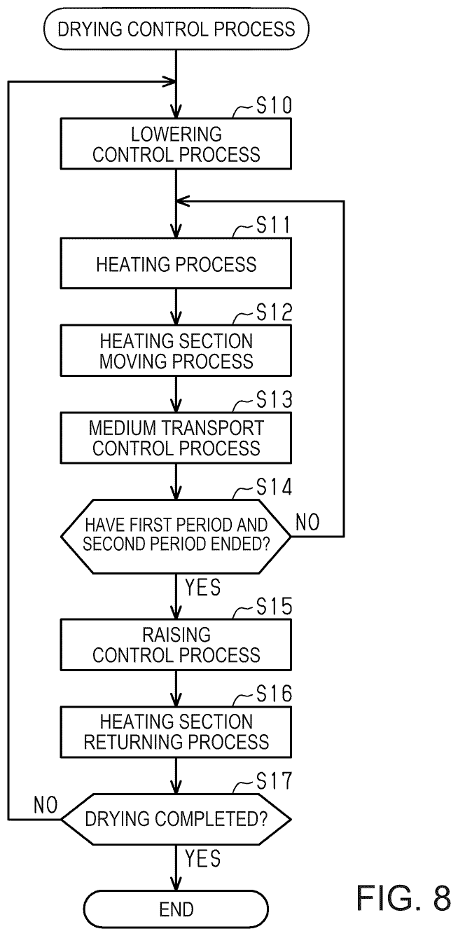

Next, a drying control process will be described with reference to FIG. 8. The drying control process is a process executed by the control section 35 when a drying instruction is received from a user.

As shown in FIG. 8, in step S10, the control section 35 executes a lowering control process. In this process, the control section 35 controls the raising/lowering section 78 to lower the second contact section 72. By this, the control section 35 performs control such that the medium 90 is sandwiched between the first contact section 71 and the second contact section 72.

In step S11, the control section 35 performs a heating process. In this process, the control section 35 controls the high-frequency voltage generation section 31 to supply a high-frequency voltage to the heating section 36. By this, the control section 35 controls the high-frequency voltage generation section 31 to drive the heating section 36.

In step S12, the control section 35 executes a heating section moving process. In this process, the control section 35 controls the movement section 75 to move the heating section 36, the first contact section 71, and the second contact section 72 in the transport direction D at a predetermined movement speed.

In step S13, the control section 35 executes a medium transport control process. In this process, the control section 35 controls the drying transport section 33 to transport the medium 90 in the transport direction D at a predetermined transport speed. The predetermined movement speed and the predetermined transport speed are the same speed.

In step S14, the control section 35 determines whether or not the first period and the second period have ended. In this process, the control section 35 determines whether or not the first period and the second period have ended, based on whether or not the time required for the provisional drying step and the main drying step has elapsed from the start of heating by the heating section 36. That is, the control section 35 determines whether or not the provisional drying step and the main drying step are completed.

When the control section 35 determines that the first period and the second period have not ended, the control section 35 shifts the process to step S11. When the control section 35 determines that the first period and the second period have ended, the control section 35 shifts the process to step S15. That is, the control section 35 repeatedly executes steps S11 to S13 until the control section 35 determines that the first period and the second period have ended.

In this manner, the control section 35 controls the movement section 75 to move the heating section 36, the first contact section 71, and the second contact section 72 in the transport direction D in a state where the medium 90 is sandwiched between the first contact section 71 and the second contact section 72. That is, the movement section 75 moves the heating section 36, the first contact section 71, and the second contact section 72 in the transport direction D in a state where the medium 90 is sandwiched between the first contact section 71 and the second contact section 72.

In step S15, the control section 35 executes a raising control process. In this process, the control section 35 controls the raising/lowering section 78 to raise the second contact section 72. By this, the control section 35 performs control so as to release the medium 90 from being sandwiched by the first contact section 71 and the second contact section 72.

In step S16, the control section 35 executes a heating section returning process. In this process, the control section 35 controls the movement section 75 to move the heating section 36, the first contact section 71, and the second contact section 72 in the second depth direction Y2. By this, the control section 35 controls the movement section 75 to move the heating section 36, the first contact section 71, and the second contact section 72 to initial positions. The initial position may be a position for drying the medium 90 before drying.

In this manner, the control section 35 controls the movement section 75 to move the heating section 36, the first contact section 71, and the second contact section 72 in a direction opposite to the transport direction D in a state where the medium 90 is released from being sandwiched by the first contact section 71 and the second contact section 72. That is, the movement section 75 moves the heating section 36, the first contact section 71, and the second contact section 72 in a direction opposite to the transport direction D in a state where the medium 90 is released from being sandwiched by the first contact section 71 and the second contact section 72.

In step S17, the control section 35 determines whether or not the drying of the medium 90 is completed. In this process, the control section 35 determines that the drying of the medium 90 is completed when a drying completion instruction is received from a user. When the control section 35 determines that the drying of the medium 90 is not completed, the control section 35 shifts the process to step S10. When the control section 35 determines that the drying of the medium 90 is completed, the control section 35 ends the drying control process. That is, the control section 35 repeatedly executes steps S10 to S16 until the control section 35 determines that the drying of the medium 90 is completed.

### Operations and Effects of Third Embodiment

Operations and effects of a third embodiment will be described.
(3-1) The movement section 75 moves the heating section 36, the first contact section 71, and the second contact section 72 in the transport direction D in a state where the medium 90 is sandwiched between the first contact section 71 and the second contact section 72. According to this configuration, it is possible to dry the medium 90 while transporting the medium 90 in the transport direction D. By this, it is possible to improve the drying performance of the medium 90. Therefore, the medium 90 can be dried while maintaining the quality of the medium 90.
(3-2) Thereafter, the movement section 75 moves the heating section 36, the first contact section 71, and the second contact section 72 in a direction opposite to the transport direction D in a state where the medium 90 is released from being sandwiched by the first contact section 71 and the second contact section 72. According to this configuration, the medium 90 can be repeatedly dried by moving the heating section 36, the first contact section 71, and the second contact section 72 in a direction opposite to the transport direction D. By this, it is possible to improve the drying performance of the medium 90. Therefore, the medium 90 can be dried while maintaining the quality of the medium 90.

### Modification

The present embodiment can be implemented with the following modifications. The present embodiment and the following modifications can be implemented in combination with each other as long as there is no technical contradiction.

In the first embodiment, the second contact section 52 may be a roller that rotates in response to a driving force from a drive source. The second contact section 52 may be a roller that rotates in response to contact with the medium 90 to be transported, regardless of a drive source.

In the second embodiment, the first contact section 61 may be a roller that rotates in response to a driving force from a drive source. The first contact section 61 may be a roller that rotates in response to contact with the medium 90 to be transported, regardless of a drive source.

In the second embodiment, the second contact section 62 may be a roller that rotates in response to a driving force from a drive source. The second contact section 62 may be a roller that rotates in response to contact with the medium 90 to be transported, regardless of a drive source.

In the third embodiment, the raising/lowering section 78 may raise and lower the heating section 36 and the first contact section 71 along the vertical direction Z. The raising/lowering section 78 may raise and lower the first heat insulating section 73 along the vertical direction Z. The raising/lowering section 78 may raise and lower the heating section 36, the first contact section 71, and the second contact section 72 along the vertical direction Z. The raising/lowering section 78 may raise and lower the first heat insulating section 73 and the second heat insulating section 74 along the vertical direction Z.

The control section 35 may continuously transport the medium 90 or may intermittently transport the medium 90.

In the heating section 36, the intensity of electromagnetic waves in the provisional drying step and the intensity of electromagnetic waves in the main drying step may not be the same. The heating section 36 may generate electromagnetic waves such that the intensity of electromagnetic waves in the provisional drying step is higher than the intensity of electromagnetic waves in the main drying step. The heating section 36 may generate electromagnetic waves such that the intensity of electromagnetic waves in the provisional drying step is lower than the intensity of electromagnetic waves in the main drying step.

The control section 35 may control the high-frequency voltage generation section 31 to generate pulsed electromagnetic waves in the provisional drying step. The control section 35 may control the high-frequency voltage generation section 31 to generate pulsed electromagnetic waves in the main drying step.

The heating section 36 is arranged so that the width direction X is a longitudinal direction, but may be arranged so that the depth direction Y is a longitudinal direction, for example. The heating section 36 may be arranged so as to be inclined with respect to the width direction X and the depth direction Y, for example.

The drying unit 30 may include a plurality of the heating sections 36. In a case where the drying unit 30 includes a plurality of the heating sections 36, the plurality of the heating sections 36 may be arranged in a plurality of rows in the width direction X. In a case where the drying unit 30 includes a plurality of the heating sections 36, the plurality of the heating sections 36 may be arranged in a plurality of rows in the depth direction Y.

The control section 35 may cause the heating section 36 itself, not the high-frequency voltage generation section 31, to control a high-frequency voltage supplied from the high-frequency voltage generation section 31 to the heating section 36. The relationship between the high-frequency voltage generation section 31 and the heating section 36 may be one to many or one to one.

The heating section 36 may be provided integrally with the first contact sections 51, 61, and 71. That is, the heating section 36 may include the first contact sections 51, 61, and 71. In this case, the first contact sections 51, 61, and 71 are provided between the first electrode 41 and the medium 90 and between the second electrode 42 and the medium 90.

At least one of the first electrode 41 and the second electrode 42 is not limited to a flat plate shape, and may be, for example, a substantially flat plate shape or a curved surface shape. The substantially flat plate shape may include, for example, a shape curved in the thickness direction, which is a direction along the vertical direction Z, or a linear shape with an extremely large aspect ratio of a rectangular shape. At least one of the first electrode 41 and the second electrode 42 may have a shape having a thickness in the vertical direction Z, and a plurality of electrode members may be connected in the vertical direction Z.

At least one of the first electrode surface 41A and second electrode surface 42A may be flat, substantially flat, or curved. The substantially planar shape may include, for example, a shape curved in the thickness direction, which is a direction along the vertical direction Z, or a linear shape with an extremely large aspect ratio of a rectangular shape.

The heating section 36 may heat the medium 90 in a state where the medium 90 is not sandwiched by the first contact sections 51, 61, and 71 and the second contact sections 52, 62, and 72 in the first period. The heating section 36 may dry the medium 90 by generating infrared rays instead of generating electromagnetic waves.

The heating section 36 may be provided in the recording device 11 instead of the drying device 12. That is, the recording device 11 may include the heating section 36. In this case, the heating section 36 may be provided on a downstream side of the recording section 20 in the transport direction D. In this manner, the heating section 36 may be applied to the recording device 11 instead of the drying device 12.

A lateral type printer may be adopted as the recording device 11. The lateral type printer is a printer in which the carriage 25 can move in two directions, a main scanning direction and a sub-scanning direction.

The medium 90 is not limited to a roll body. The medium 90 may be a paper sheet, a resin film or sheet, a resin-metal composite film, a laminate film, a textile, a nonwoven fabric, a metal foil, a metal film, a ceramic sheet, a garment, or the like.

Liquid can be any pigment ink that records on the medium 90 by depositing to the medium 90. Pigment ink may contain a solvent other than glycerin. In such a case, the irradiation intensity of electromagnetic waves on the medium may be varied depending on the boiling point of the solvent contained in pigment ink and the ratio of a solvent. Specifically, the irradiation intensity of electromagnetic waves on the medium can be adjusted by adjusting at least one of a first pulse width, a second pulse width, the number of times that an electromagnetic wave is generated with the second pulse width, the intensity of electromagnetic waves, and the number and arrangement of the heating section 36. Liquid may be other than pigment ink.

As used herein, the phrase “at least any” means one or more of the desired options. As an example, the phrase “at least any” as used herein means only one option if the number of options is two, or both of the two options. As another example, the phrase “at least any” as used herein means only one option or a combination of any two or more options when the number of options is three or more.

### Notes

Hereinafter, technical ideas grasped from the above-described embodiments and modifications, and operations and effects thereof will be described. The present technical ideas and the operations and effects thereof can be combined with each other within a technically consistent range.
(A) A drying device includes a heating section that heats a medium on which was ejected pigment ink containing a pigment, water, and a solvent; a first contact section that is provided between the heating section and the medium and that is configured to contact the medium; and a second contact section that is provided at a position sandwiching the medium with respect to the heating section and that is configured to contact the medium, wherein the heating section, in a first period, vaporizes the water contained in the pigment ink by heating the pigment ink that was ejected onto the medium in a state where the medium is sandwiched between the first contact section and the second contact section and then, in a second period, vaporizes the solvent contained in the pigment ink by heating the pigment ink that was ejected onto the medium in a state where the medium is sandwiched between the first contact section and the second contact section and the drying device releases the medium from being sandwiched by the first contact section and the second contact section after the medium is heated by the heating section.

According to this configuration, when a solvent is vaporized in the second period, moisture vaporized in the first period remains in the vicinity of the medium. This makes it possible to reduce the difference in the amount of heat generated by pigment ink depending on the type of the medium and the type of liquid. In addition, since the airtightness between the first contact section and the second contact section and the medium can be improved, the medium can be dried in an environment in which pigment ink is unlikely to be oxidized. It is possible to suppress the imbalance of the distance between the medium and the heating section. It is possible to suppress the contraction of the medium in accordance with the heating of the medium. Therefore, it is possible to suppress the occurrence of thermal denaturation with respect to the medium. Therefore, it is possible to dry the medium while maintaining the quality of the medium.
(B) The above-described drying device may be configured such that the drying device further includes a blower section that blows air to the medium that was released from being sandwiched by the first contact section and the second contact section.

According to this configuration, after water is vaporized from the medium in the first period and a solvent is vaporized from the medium in the second period, water and a solvent vaporized from the medium can be removed from the vicinity of the medium. Therefore, it is possible to improve the drying performance of the medium and to improve the abrasion resistance. Therefore, it is possible to dry the medium while maintaining the quality of the medium.
(C) The above-described drying device may be configured such that the heating section includes a first electrode, a second electrode arranged so as to surround the first electrode in plan view from a first direction toward the medium, a first conductor that includes a coil and that electrically connects a transmission line, which is configured to transmit a high-frequency voltage, and the first electrode, and a second conductor that electrically connects the transmission line and the second electrode and the heating section generates an electromagnetic wave in response to application of a high-frequency voltage to heat the medium onto which the pigment ink was ejected.

According to this configuration, the medium can be dried in a short time by boiling pigment ink ejected onto the medium. In addition, even when electromagnetic waves having high intensity are generated, it is possible to suppress the occurrence of thermal denaturation with respect to the medium. Therefore, it is possible to dry the medium while maintaining the quality of the medium.
(D) The above-described drying device may be configured such that at least one of the first contact section and the second contact section includes a contact surface that contacts the medium and that has an indentation-protrusion shape.

According to this configuration, it is possible to increase the amount of moisture that is remained in the vicinity of the medium, and it is possible to improve the transport property of the medium. Therefore, it is possible to dry the medium while maintaining the quality of the medium.
(E) The above-described drying device may be configured such that at least one of the first contact section and the second contact section is configured to include glass.

According to this configuration, it is possible to improve the transport property of the medium by including glass in at least one of the first contact section and the second contact section.
(F) The above-described drying device may be configured such that the drying device further includes a movement section that moves the heating section, the first contact section, and the second contact section along a transport direction in which the medium is transported, wherein the movement section moves the heating section, the first contact section, and the second contact section in the transport direction in a state where the medium is sandwiched between the first contact section and the second contact section, and then moves the heating section, the first contact section, and the second contact section in a direction opposite to the transport direction in a state where the medium is released from being sandwiched by the first contact section and the second contact section.

According to this configuration, the medium can be dried while being transported in the transport direction by moving the heating section, the first contact section, and the second contact section in the transport direction. In addition, the medium can be repeatedly dried by moving the heating section, the first contact section, and the second contact section in a direction opposite to the transport direction. By this, it is possible to improve the drying performance of the medium. Therefore, it is possible to dry the medium while maintaining the quality of the medium.
(G) The above-described drying device may be configured such that the first contact section includes a curved surface.

According to this configuration, in a case where the medium is transported along a curved transport path, it is possible to improve the airtightness between the medium and the first contact section. Therefore, it is possible to suppress the occurrence of thermal denaturation with respect to the medium. Therefore, it is possible to dry the medium while maintaining the quality of the medium.
(H) The above-described drying device may be configured such that the second contact section is a roller including a curved surface.

According to this configuration, in a case where the medium is transported along the second contact section including a curved surface, it is possible to improve the airtightness between the medium and the second contact section, and to improve the transport property of the medium. Therefore, it is possible to suppress the occurrence of thermal denaturation with respect to the medium. Therefore, it is possible to dry the medium while maintaining the quality of the medium.
(I) A recording device includes a recording section that performs recording by ejecting pigment ink containing a pigment, water, and a solvent onto a medium; a heating section that heats the medium onto which the pigment ink was ejected by the recording section; a first contact section that is provided between the heating section and the medium and that is configured to contact the medium; and a second contact section that is provided at a position sandwiching the medium with respect to the heating section and that is configured to contact the medium, wherein the heating section, in a first period, vaporizes the water contained in the pigment ink by heating the pigment ink that was ejected onto the medium in a state where the medium is sandwiched between the first contact section and the second contact section and then, in a second period, vaporizes the solvent contained in the pigment ink by heating the pigment ink that was ejected onto the medium in a state where the medium is sandwiched between the first contact section and the second contact section and the recording device releases the medium from being sandwiched by the first contact section and the second contact section after the medium is heated by the heating section.

According to this configuration, the same effect as in (A) can be achieved.

What is claimed is:

1. A drying device comprising:
a heating section that heats a medium on which was ejected pigment ink containing a pigment, water, and a solvent;
a first contact section that is provided between the heating section and the medium and that is configured to contact the medium; and
a second contact section that is provided at a position sandwiching the medium with respect to the heating section and that is configured to contact the medium, wherein
the heating section, in a first period, vaporizes the water contained in the pigment ink by heating the pigment ink that was ejected onto the medium in a state where the medium is sandwiched between the first contact section and the second contact section and then, in a second period, vaporizes the solvent contained in the pigment ink by heating the pigment ink that was ejected onto the medium in a state where the medium is sandwiched between the first contact section and the second contact section and
the drying device releases the medium from being sandwiched by the first contact section and the second contact section after the medium is heated by the heating section.

2. The drying device according to claim 1, further comprising:
a blower section that blows air to the medium that was released from being sandwiched by the first contact section and the second contact section.

3. The drying device according to claim 1, wherein
the heating section includes
a first electrode,
a second electrode arranged so as to surround the first electrode in plan view from a first direction toward the medium,
a first conductor that includes a coil and that electrically connects a transmission line, which is configured to transmit a high-frequency voltage, and the first electrode, and
a second conductor that electrically connects the transmission line and the second electrode and
the heating section generates an electromagnetic wave in response to application of a high-frequency voltage to heat the medium onto which the pigment ink was ejected.

4. The drying device according to claim 1, wherein
at least one of the first contact section and the second contact section includes a contact surface that contacts the medium and that has an indentation-protrusion shape.

5. The drying device according to claim 1, wherein
at least one of the first contact section and the second contact section is configured to include glass.

6. The drying device according to claim 1, further comprising:
a movement section that moves the heating section, the first contact section, and the second contact section along a transport direction in which the medium is transported, wherein
the movement section moves the heating section, the first contact section, and the second contact section in the transport direction in a state where the medium is sandwiched between the first contact section and the second contact section, and then moves the heating section, the first contact section, and the second contact section in a direction opposite to the transport direction in a state where the medium is released from being sandwiched by the first contact section and the second contact section.

7. The drying device according to claim 1, wherein
the first contact section includes a curved surface.

8. The drying device according to claim 1, wherein
the second contact section is a roller including a curved surface.

9. A recording device comprising:
a recording section that performs recording by ejecting pigment ink containing a pigment, water, and a solvent onto a medium;
a heating section that heats the medium onto which the pigment ink was ejected by the recording section;
a first contact section that is provided between the heating section and the medium and that is configured to contact the medium; and
a second contact section that is provided at a position sandwiching the medium with respect to the heating section and that is configured to contact the medium, wherein
the heating section, in a first period, vaporizes the water contained in the pigment ink by heating the pigment ink that was ejected onto the medium in a state where the medium is sandwiched between the first contact section and the second contact section and then, in a second period, vaporizes the solvent contained in the pigment ink by heating the pigment ink that was ejected onto the medium in a state where the medium is sandwiched between the first contact section and the second contact section and
the recording device releases the medium from being sandwiched by the first contact section and the second contact section after the medium is heated by the heating section.
